(19) United States
(12) Patent Application Publication
(10) Pub. No.: US 2002/0046103 A1
(43) Pub. Date: Apr. 18, 2002

(54) Information dispensing system

(76) Inventor: Joseph P. Rudolph, South Park, PA (US)

Correspondence Address: JAMES RAY & ASSOCIATES, 2640 PITCAIRN ROAD, MONROEVILLE, PA, 15146, US

(21) Appl. No.: 09/841,903

(22) Filed: Apr. 25, 2001

Related U.S. Application Data
(60) Provisional application No. 60/216,111, filed on Jul. 6, 2000.

(51) Int. Cl. G06F 17/60

(52) U.S. Cl. 705/14

(57) ABSTRACT

A system for enabling a person to select relatively small packets of specific information from a relatively large database comprising a central station having a transmitter for transmitting such relatively large database and a hand held unit for use by a person at a location remote from the central station. Such hand held unit includes a data receiver for receiving and storing the relatively large database and a display screen for displaying portions of such relatively large database. A selection device is provided for selecting the small packets of specific information. There is also a device for providing output of these small packets of specific information.

### CROSS-REFERENCE TO RELATED APPLICATIONS

This application relates to and claims priority of provisional patent application serial no. 60/216,111 filed Jul. 6, 2000.

### FIELD OF THE INVENTION

The present invention relates, in general, to dissemination of information from central transmitters and, more particularly, this invention relates to such dissemination of the information to a hand-held unit and to the display or output of selected packets from such hand-held unit. Still more particularly, this invention is directed to the dissemination of at least one of coupons, certificates of value and other consumer information.

### BACKGROUND OF THE INVENTION

Prior to the development of the present invention, it has been 11 recognized that the systems being used to advertise goods and services and providing coupons to consumers by hardcopy has numerous disadvantages. It has also been seen that electronic distribution of coupons and other consumer information and electronic selection by the consumer has the potential for considerable savings.

For example, a number of patents exist which teach the use of broadcast television, or cable television networks, to communicate commercial information to consumers and to enable the consumer to select all or any specific portion of this consumer information. In some of the systems proposed, when the consumer sees a commercial on television they can select and print a coupon for the particular product or service being advertised. These systems, however, generally require rather expensive modification to the television system as well as the expense of receivers at the consumer's location. Additionally, due to time constraints, these commercials are usually only seen for a relatively short period of time thereby making it rather difficult to use these type systems. This would particularly be the case for the elderly.

For these reasons, none of these systems, to the best of applicant's knowledge have ever been adopted by the consuming public.

### SUMMARY OF THE INVENTION

According to a first aspect, the present invention provides a system for enabling a person to select relatively small packets of specific information, from a relatively large database, for rather specific purposes. The system includes a central station having a transmitter for transmitting a relatively large database. Such system further includes a hand held unit for use by a person at a location remote from such central station. The hand held unit has a data receiver for receiving and storing the relatively large database and a display screen for displaying portions of such relatively large database. Such hand held unit further includes a means for selecting such small packets of specific information and a means for providing output of these small packets of specific information.

According to a second aspect, the present invention provides a method for enabling a person to select relatively small packets of rather specific information from a relatively large body of information. Such method including the steps of broadcasting, from a predetermined location, a database indicative of such relatively large body of information. Thereafter receiving the database broadcast into a hand held unit at a location remote from the predetermined location. Displaying portions of the database received on a display screen of the hand held unit and then viewing portions of the database displayed. Thereafter, selecting at least one of the relatively small packets of specific information viewed and then requesting output of such at least one of the relatively small packets of specific information selected.

### OBJECTS OF THE INVENTION

It is, therefore, one of the primary objects of the present invention to provide a system to communicate certificates of value and consumer information to small hand held units which consumers may carry with them in any convenient manner.

Another object of the present invention is to provide a method for communicating and providing hardcopy of certificates of value and consumer information to small hand held units which consumers may use in commercial establishments.

Still another object of the present invention is to provide a system which is capable of communicating certificates of value such as coupons and tokens to systems installed at commercial establishments.

Yet another object of the present invention is to provide a system to communicate certificates of value and other consumer information to small hand held units which will reduce coupon fraud by providing coupons with serial numbers or other unique user identifiers.

An additional object of the present invention is to provide a system to communicate certificates of value and other consumer information to small hand held units which is relatively easy to use.

A further object of the present invention is to provide a system to communicate certificates of value and other consumer information to small hand held units which is portable and light weight.

Still yet another object of the present invention is to provide a system to communicate certificates of value and other consumer information to small hand held units which will require a minimum amount of maintenance.

Yet still another object of the present invention is to provide a system to communicate certificates of value and other consumer information to small hand held units which is relatively inexpensive to manufacture.

It is an additional object of the present invention to provide a system to communicate certificates of value and other consumer information to small hand held units which may be used for additional purposes thereby enhancing the value of the system to the consumer.

In addition to the various objects and advantages of the present invention which have been generally described above, there will be various other objects and advantages of the invention that will become more readily apparent to those persons who are skilled in the relevant art from the following more detailed description of the invention, particularly, when the detailed description is taken in conjunction with the attached drawing figures and with the appended claims.

### BRIEF DESCRIPTION OF THE DRAWINGS

FIG. 1 is a schematic illustration of a central station having a transmitter and a database according to a presently preferred embodiment of the invention;

FIG. 2 is a schematic illustration showing a radio signal transmission tower with an antenna connected to the transmitter shown in FIG. 1;

FIG. 3 schematically illustrates a front view of a presently preferred embodiment of a hand held unit for use in a presently preferred embodiment of the invention;

FIG. 4 schematically illustrates the back side of the hand held unit illustrated in FIG. 3.

FIG. 5 schematically illustrates a front view of an alternative embodiment of a hand held unit for use the invention which includes a printer.

### BRIEF DESCRIPTION OF THE PRESENTLY PREFERRED AND VARIOUS ALTERNATIVE EMBODIMENTS OF THE INVENTION

Prior to proceeding to the more detailed description of the instant invention it should be noted the identical components, having identical functions, have been identified with identical reference numerals throughout the several views which have been illustrated in the drawing figures.

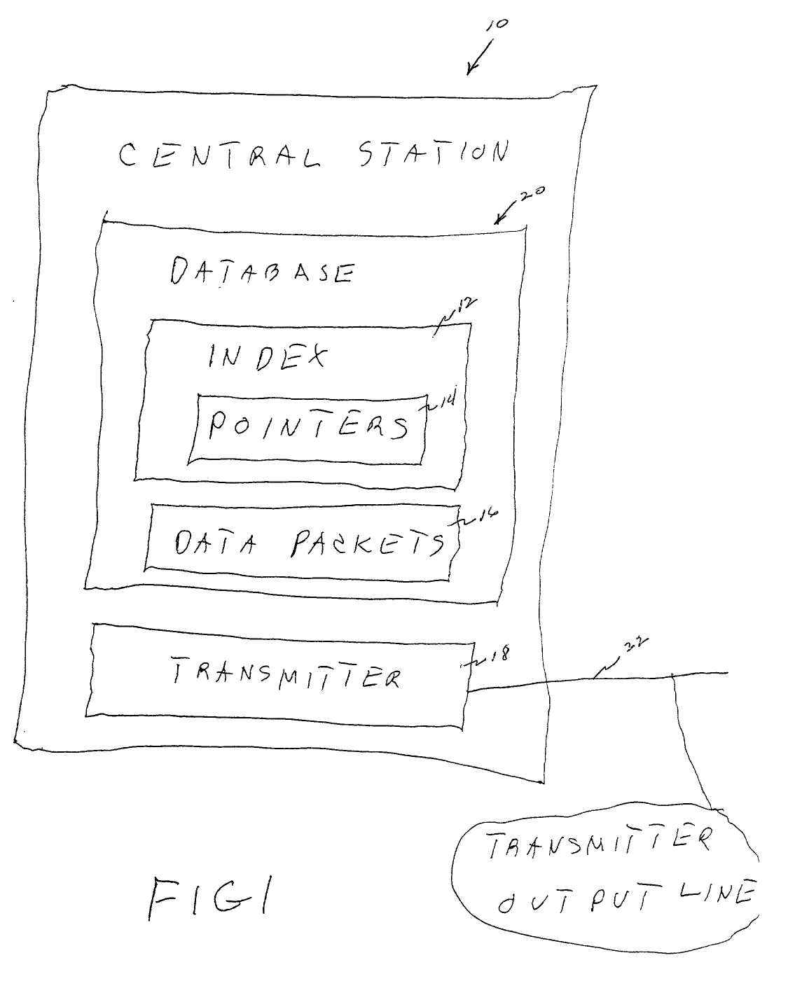

Reference is now directed, more particularly, to FIG. 1. Illustrated therein are the essential elements of a central station, generally designated 10. The central station 10 includes a database, generally designated 20, which may, for example, be disposed in a computer (not shown). The database 20 comprises an index 12, pointers 14 and data packets 16 which, preferably, are located by the pointers 14. Although not to be limited thereto, these data packets 16 may, for example, be ASCII text, graphical computer files such as JPEG or BMP files or other unspecified data. In the presently preferred embodiment of the invention, the pointers 14 define the locations of the data packets 16 in memory.

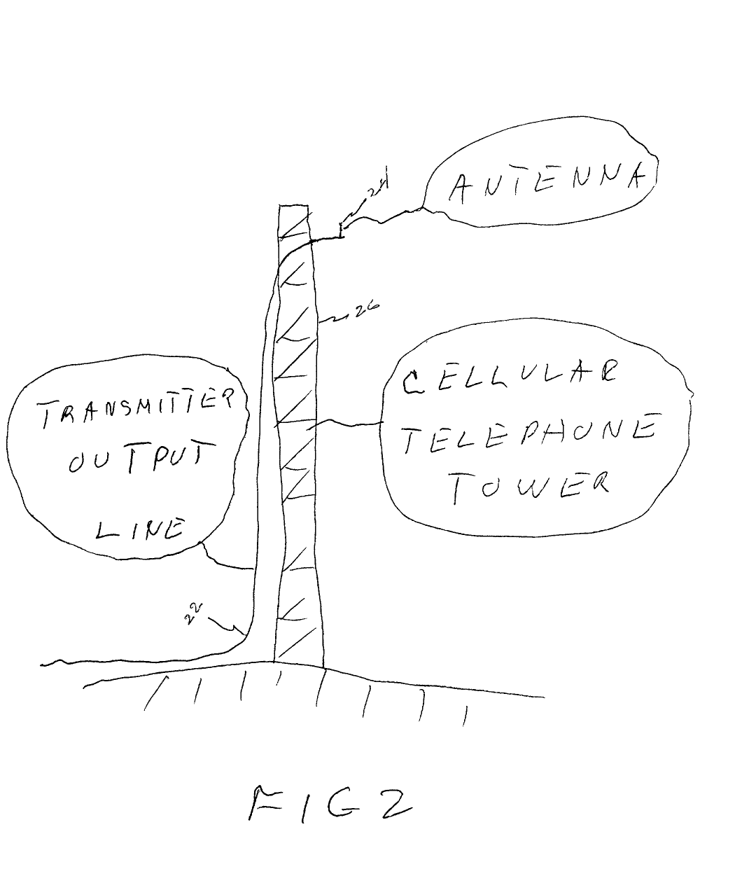

The central station 10 also includes a transmitter 18 for transmitting the database 20 and a transmitter output line 22 attached to the antenna 24 (FIG. 2) on a radio frequency transmission tower 26. Alternatively, a microwave link may be employed in lieu of the transmitter output line 22.

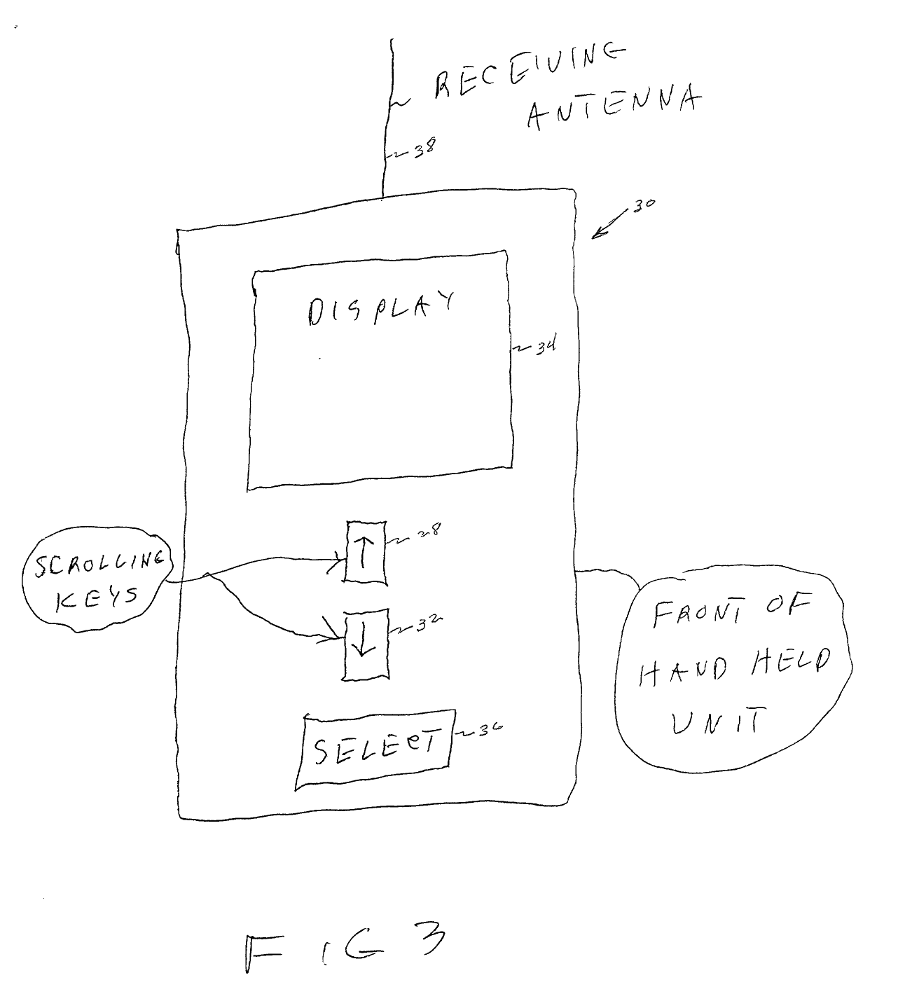

Reference is now directed to FIG. 3. Illustrated therein is a front view of a presently preferred embodiment of a hand held unit, generally designated 30, which is employed in the invention. Hand held unit 30 has two buttons 28 and 32 for scrolling through the database 20. Hand held unit 30 further includes a display screen 34. Hand held unit 30 has a select key 36, which when depressed, selects specific data for storage, reporting, printing or other functions. Further hand held unit 30 includes a receiving antenna 38 for receiving output from radio frequency transmission tower 26.

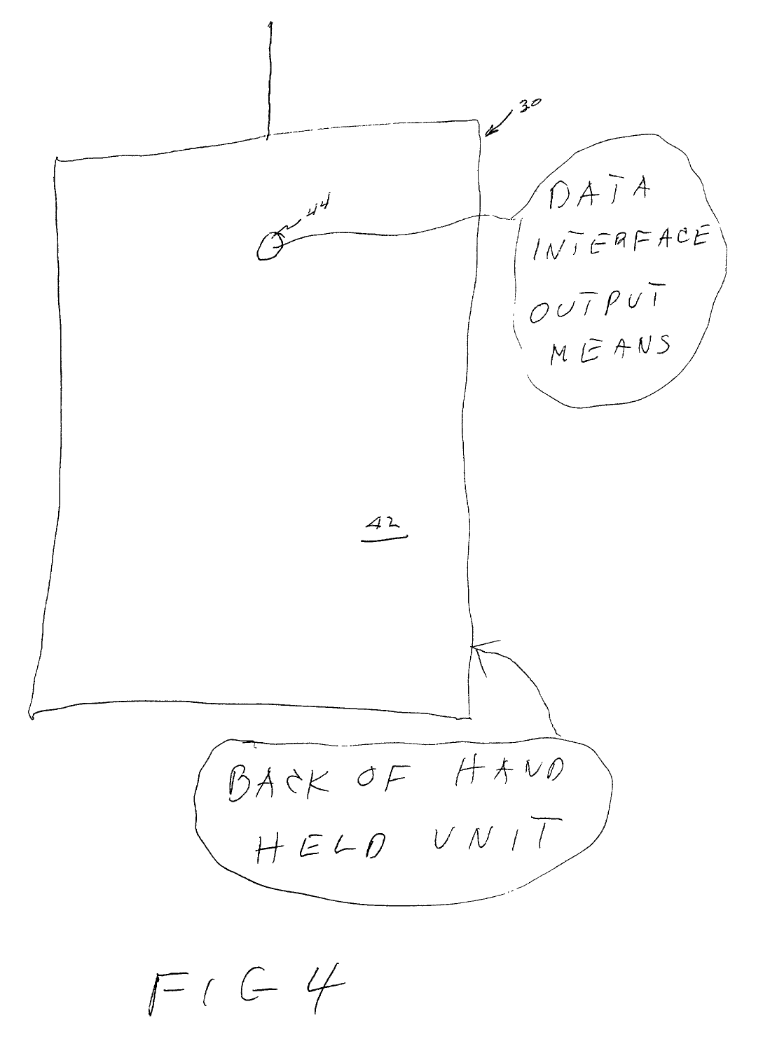

As can be seen in FIG. 4 the back side 42 of the hand held unit 30 includes a data interface output means 44 which may include a modulated source of infrared, visible or ultraviolet light. Alternatively, the data interface output means 44 may include a microwave transmitter (not shown). In the presently preferred embodiment, the data interface output means 44 is a physical electrical connector (not shown). The physical electrical connector enables a connection to a docking station at, for example, a commercial establishment, computer or other device (not shown). The hand held unit 30 may optionally include a physical connector for a telephone, cable television, computer or other data input device.

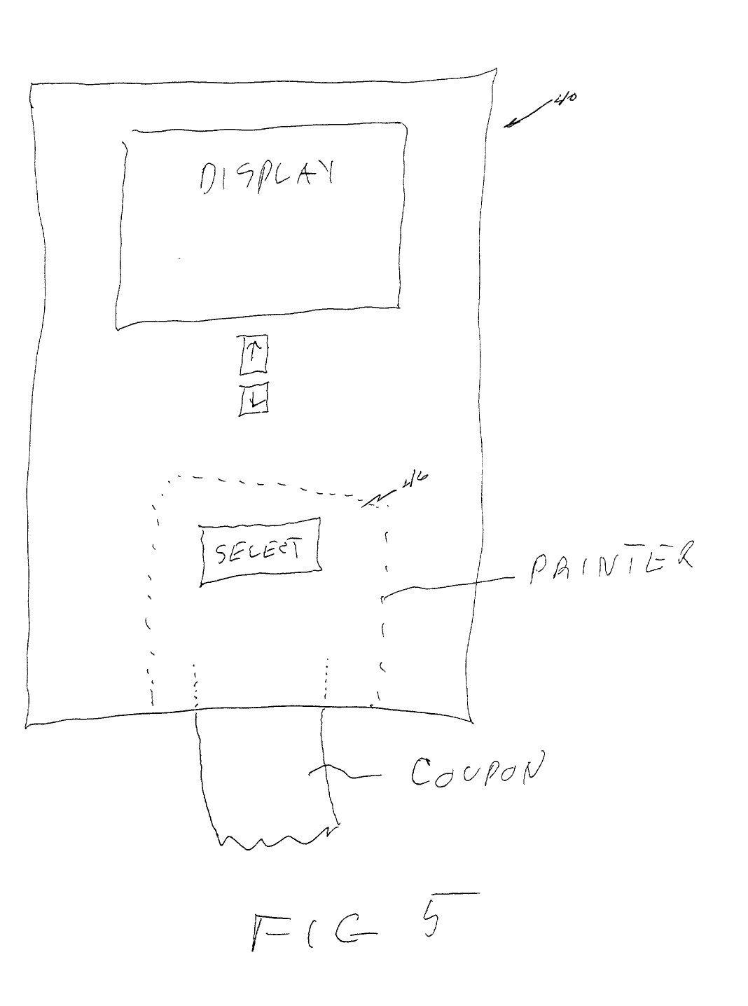

Illustrated in FIG. 5 is a front view of an alternative embodiment of a hand held unit, generally designated 40, which includes a printer 46, indicated by dashed lines, for printing a coupon, token, or other certificate of value.

As discussed supra, in a first aspect, the present invention provides a system which includes a central station 10 having a database 20. The database 20 includes many relatively small packets 16 of specific information. The packets 16, for example, may represent certificates of value such as coupons, tokens or prize notifications. The packets 16 may also represent consumer information such as advertisements. The database 20 is located in the central station 20 which has a transmitter 18 for transmitting the database 20 to hand held units 30 which have data receivers.

For example, the transmitter may be a radio transmitter utilizing a rather narrow band frequency for data transmission. The hand held unit 30 would have a radio receiver.

Each hand held unit 30 has a display screen 34 for displaying portions of the database 20, selecting individual packets 16 of information and providing output of the selected packets 16.

Preferably, the database 20 includes an index 12, characterizing the relatively small packets 16 of information, and pointers 14 to locations of individual packets 16 in the database 20.

Each individual packet 16 may include a graphic portion and a reference in the index 12. The graphic portions may be individual binary computer files in JPEG or BMP format. These files may be produced by a computer scanner using graphic material on hardcopy as input. The graphic material may be converted to a digital format using ASCII text to define pixel patterns. These transmitted pixel patterns then provide the graphical display output of the hand held unit 30 on the display screen 34.

Preferably, the hand held unit 30 will include at least two keys 28 and 32 for scrolling through the index 12 and a key 36 or other means for selecting individual packets 16 of information for output or storage. A touch screen, for example, may be used to select individual packets 16 for output.

The output may be a printer. If the individual packets 16 of information represent coupons, the printer would provide printed coupons. The coupons may include printed trademarks or service marks.

Alternatively or additionally, output may be by a data interface output means. For example, the output may be a modulated source of infrared light, visible light or ultraviolet light.

It is further contemplated to be within the scope of the present invention that the output may be by a bar code display which could be read by bar code readers at commercial establishments. The bar code may be displayed on the display screen 34 of the hand held unit 30. In order to provide a bar code output, the display should be reflective such as a liquid crystal display, rather than a light source such as LED's. This is so the bar code can be read by bar code readers. With such an output, no paper coupon is necessary and no modification of the checkout hardware at commercial establishments is necessary. Nevertheless, the bar code may be read and a coupon printed.

As another alternative, the output may be communicated to a computer. The computer may be equipped to directly print data, or it may use programming and a database to interact with downloaded data from the hand held unit 30 to perform computations and/or display of new information, data, advertisements, or coupons. The computer database may be provided by several sources, such as, CD ROM, internet, or data input by the user such as demographic data.

Alternatively, the output form the hand held unit 30 may be linked to other data sources. For example only, the user may be guided to a particular website to obtain information, coupons or other data. Such hand held unit 30 may further include a display of specific coding or passwords to enable the user to uniquely access a website or other data source.

The relatively small data packets 16 may also include digital audio information, in which case the hand held unit 30 includes a loudspeaker or other audio output (not shown). For the case in which the data packets 16 represent coupons, the audio information could be suggestive of the product and/or the service being advertised.

The index 12 may be structured as a logical tree so that a person may quickly find information of interest. Someone shopping for an electric drill could go to HARDWARE—TOOLS—SMALL ELECTRIC —TOOLS. A person shopping for strawberries could go to GROCERIES—PRODUCE—FRUIT. The index 12 may also be written in hypertext markup language so a person can rapidly access a desired portion of the index 12. A program in the hand held unit 30 may also include a method for a person to bookmark one or more specific packets 16 of information. A person going shopping may, for example, select coupons and advertisements of interest and bookmark them for quick reference. The index 12 may also include the names of individual vendors so that a person shopping for a certain item at a certain vendor will see other products and/or services offered by that vendor.

The transmitter may communicate the database to the hand held unit 30 by landlines such as telephone, cable lines, or internet access in which case the hand held units 30 have connectors for attachment to the landlines.

For the case in which the same trademarks or service marks are to be included in the output for individual packets 16, data indicative of the trademarks or service marks may be stored in the hand held units 30 and indexed in the index 12 for reference. Signals sent from the central station 10 may include revisions to the data indicative of the trademarks or service marks.

The invented system may also include a printer (not shown) separate from the hand held units 30 and separate from the central station 10. The printer has means for receiving the output of the specific packets 16 of information. For example, printers may be located at various uncongested places in a store. A person may use his hand held unit 30 to select a coupon or other certificate of value, and print it to present during checkout or for later use.

In another embodiment, the hand held unit 30 includes a transmitter 18 which a person may employ to send a signal to the central station 10 to transmit a selected data packet 16 to a printer which is remote from the hand held unit 30 and from the central station 10. When a person is not at home, they could use this feature to print selected coupons at his or her home.

The hand held units 30 may have individual identifiers, and the output from the hand held unit 30 may include the identifier. With this feature, the shopping habits of individuals may be tracked.

The individual packets 16 of information may include an integer variable which is indicative of the number of copies of the packet 16 which may be made. When one of the packets 16 is provided as output, the integer would be decremented by unity. The system may provide, therefore, limited numbers of identical coupons, tokens, etc.

While the presently preferred embodiment for carrying out the instant invention has been set forth in detail according to the Patent Act, those persons skilled in the relevant art to which this invention pertains will recognize various alternative ways of practicing the invention without departing from the spirit and scope of the claims appended hereto.

I claim:

1. A system for enabling a person to select relatively small packets of specific information from a relatively large database, said system comprising:
(a) a central station having a transmitter for transmitting said relatively large database, and
(b) a hand held unit for use by a person at a location remote from said central station, said hand held unit including;
(i) a data receiver for receiving and storing said relatively large database,
(ii) a display screen for displaying portions of said relatively large database,
(iii) means for selecting said small packets of specific information, and
(iv) means for providing output of said small packets of specific information.

2. A system, according to claim 1, wherein said database includes an index characterizing said relatively small packets of specific information.

3. A system, according to claim 2, wherein said index includes at least one pointer for pointing to locations of said relatively small packets of specific information in said database.

4. A system, according to claim 2, wherein said hand held unit has at least two keys for scrolling through said index and at least one key for selecting said relatively small packets of specific information.

5. A system, according to claim 1, wherein said means for selecting said relatively small packets of specific information includes a touch screen.

6. A system, according to claim 1, wherein said means for providing output of said small packets of specific information includes a printer.

7. A system, according to claim 1, wherein said means for providing output of said small packets of specific information includes a data interface output means.

8. A system, according to claim 7, wherein said data interface output means includes a modulated source of at least one of infrared light, visible light and ultraviolet light.

9. A system, according to claim 7, wherein said data interface output means includes a microwave transmitter.

10. A system, according to claim 7, wherein said data interface output means includes a physical electrical connector.

11. A system, according to claim 1, wherein said database includes at least a portion thereof in hypertext markup language format.

12. A system, according to claim 1, wherein data transmitted in ASCII text format is converted and displayed as one of graphical and pictorial images.

13. A system, according to claim 12, wherein said one of said graphical and pictorial images are converted into code using ASCII text format.

14. A system, according to claim 4, wherein said at least one key for selecting said relatively small packets of information includes a key for providing a bookmark indicative of a position of at least one of said relatively small packets of specific information.

15. A system, according to claim 2, wherein said index characterizing said relatively small packets of specific information is structured as a logical tree.

16. A system, according to claim 1, wherein said transmitter broadcasts radio waves indicative of said database and said data receiver includes a radio receiver.

17. A system, according to claim 16, wherein said transmitter broadcasts said radio waves from at least one radio frequency transmission tower.

18. A system, according to claim 1, wherein said transmitter sends signals indicative of said database over at least one landline and said hand held unit includes a connector for attachment to said at least one landline.

19. A system, according to claim 1, wherein said relatively small packets of specific information include at least one of coupons, tokens, advertisements and consumer information.

20. A system, according to claim 1, wherein said small packets of specific information includes graphical data representative of trademarks.

21. A system, according to claim 20, wherein said central station includes means for transmitting information indicative of revisions to said graphical data.

22. A system, according to claim 1, wherein said hand held unit provides an output linked to a unique identification of a user to prevent fraudulent use of at least one of said hand held unit, data output, coupons and other functions of said system.

23. A system, according to claim 1, wherein said means for providing output includes a bar code display capable of being read by commercial bar code readers.

24. A system, according to claim 23, wherein said bar code display is a liquid crystal display.

25. A system, according to claim 23, wherein said system further includes a bar code reader interprets a bar code displayed by said hand held unit and displays additional data which may be accessed by a user.

26. A system, according to claim 25, wherein said bar code reader prints at least one of coupons and tokens of value based on said bar code displayed by said hand held unit.

27. A system, according to claim 25, wherein said bar code reader credits user of said hand held unit for at least one of discounts, coupons, advertisements and other benefits stored in a database of said bar code reader.

28. A system, according to claim 1, wherein said small packets of specific information include digital audio data and said hand held unit includes an audio output to provide an audio signal indicative of said digital audio data.

29. A system, according to claim 1, wherein said hand held unit has a unique identifier and said unique identifier is provided as output with said small packets of specific information.

30. A system, according to claim 29, wherein said unique identifier is used to track usage of said hand held unit for at least one of demographic data, marketing and other uses of vendors providing data to said hand held unit database.

31. A system, according to claim 1, wherein said output includes at least one unique identifier used to track usage of said hand held unit for at least one of demographic data, marketing and other uses.

32. A system, according to claim 2, wherein said index characterizing said relatively small packets of specific information includes names of specific vendors and said small packets of specific information are at least one of coupons, tokens, advertisements and consumer information provided by said vendors.

33. A system, according to claim 1, wherein said system further includes a printer separate from said hand held unit and separate from said central station, said printer having means for receiving said output of said relatively small packets of specific information and for printing certificates of value indicative of said relatively small packets of specific information.

34. A system, according to claim 1, wherein said hand held unit includes a transmitter for sending a signal to said central station to transmit at least one of said relatively small packets of specific information to a printer remote from said hand held unit and remote from said central station.

35. A system, according to claim 1, wherein at least one of said relatively small packets of specific information includes an integer variable which is assigned an initial value when said at least one of said relatively small packets of specific information is transmitted and wherein said hand held unit decrements said integer when output is provided for said at least one of said relatively small packets of specific information.

36. A system, according to claim 1, wherein said system further includes a computer and data from said hand held unit is input to said computer for at least one of displaying, processing, selection and printing of data.

37. A system, according to claim 1, wherein said system further includes means for connection to additional data sources and said data stored in said hand held unit directs a user to said additional data sources.

38. A system, according to claim 37, wherein said additional data sources are websites.

39. A system, according to claim 1, wherein data from said hand held unit provides a user access to restricted databases selected from at least one of computers, coupon printers and websites.

40. A method for enabling a person to select relatively small packets of specific information from a relatively large body of information, said method comprising the steps of:
(a) broadcasting, from a predetermined location, a database indicative of said relatively large body of information;
(b) receiving said database broadcast in step (a) into a hand held unit at a location remote from said predetermined location,
(c) displaying portions of said database received in step (b) on a display screen of said hand held unit;
(d) viewing portions of said database displayed in step (c);
(e) selecting at least one of said relatively small packets of specific information viewed in step (d); and
(f) requesting output of said at least one of said relatively small packets of specific information selected in step (e).

41. A method, according to claim 40, wherein said method includes an additional step of interacting with at least one secondary device selected from printers, computers, bar code readers and bar code displays.

42. A method, according to claim 40, wherein said method includes an additional step of accessing at least one secondary database selected from computer based data and websites.
